(19) United States
(12) Patent Application Publication
(10) Pub. No.: US 2025/0167292 A1
(43) Pub. Date: May 22, 2025

(54) SOLID-STATE BATTERY

(71) Applicant: Chung Yuan Christian University, Taoyuan City (TW)

(72) Inventors: Wei-Jen Liu, Taoyuan City (TW); Yin-Chen Hsu, Taoyuan City (TW); Rasu Muruganantham, Taoyuan City (TW)

(73) Assignee: Chung Yuan Christian University, Taoyuan City (TW)

(21) Appl. No.: 18/409,793

(22) Filed: Jan. 11, 2024

(30) Foreign Application Priority Data
Nov. 22, 2023 (TW) 112145123

(51) Int. Cl. H01M 10/0562; H01M 4/02; H01M 4/505; H01M 4/525; H01M 10/0525

(52) U.S. Cl. CPC H01M 10/0562; H01M 2004/028; H01M 4/505; H01M 4/525; H01M 10/0525; H01M 2300/008

(57) ABSTRACT

A solid-state battery includes a positive electrode, a negative electrode, and a solid-state electrolyte layer. The solid-state electrolyte layer is disposed between the positive electrode and the negative electrode. The solid-state electrolyte layer includes a sulfide solid-state electrolyte represented by Chemical formula 1,

Li_{6+x+y}P_{1-x-y}SiₓTi_{y}S_{5-2x-2y}BrO_{2x+2y} [Chemical formula 1]
where in Chemical formula 1, 0≤x≤0.5, 0≤y≤0.5, and x+y>0.

### CROSS-REFERENCE TO RELATED APPLICATION

This application claims the priority benefit of Taiwan application serial no. 112145123, filed on Nov. 22, 2023. The entirety of the above-mentioned patent application is hereby incorporated by reference herein and made a part of this specification.

### BACKGROUND

### Technical Field

The disclosure relates to a battery, and more particularly, to a solid-state battery.

### Description of Related Art

With the development of the industry, liquid lithium batteries are widely used in electronic products, such as laptops, mobile phones, wearable devices, etc., and even in the electric vehicle industry. However, when the liquid lithium batteries are impacted by external forces, dangers such as combustion and explosion may occur due to factors such as leakage and volatilization of flammable electrolyte solutions therein. Therefore, in order to improve safety of batteries, research on solid-state lithium batteries has recently begun, using solid-state electrolytes to replace the electrolyte solutions in the liquid lithium batteries to avoid possible dangers caused by the leakage and volatilization of the electrolyte solutions.

Among the solid-state electrolytes, sulfide solid-state electrolytes have high ionic conductivity. However, the sulfide solid-state electrolytes have poor stability, and are easily decomposed in the air or in high voltage environments, affecting performance thereof. Therefore, how to improve the stability of the sulfide solid-state electrolytes is currently an issue that is required to be solved.

### SUMMARY

The disclosure provides a solid-state battery, which has good chemical and voltage stability and may improve cycle life.

A solid-state battery in the disclosure includes a positive electrode, a negative electrode, and a solid-state electrolyte layer. The solid-state electrolyte layer is disposed between the positive electrode and the negative electrode. The solid-state electrolyte layer includes a sulfide solid-state electrolyte, and the sulfide solid-state electrolyte is represented by Chemical formula 1,

Li_{6+x+y}P_{1-x-y}SiₓTi_{y}S_{5-2x-2y}BrO_{2x+2y} [Chemical formula 1]

where in Chemical formula 1, 0≤x≤0.5, 0≤y≤0.5, and x+y>0.

In an embodiment of the disclosure, the sulfide solid-state electrolyte is represented by Chemical formula 2,

Li₆₊ₓP₁₋ₓSiₓS₅₋₂ₓBrO₂ₓ [Chemical formula 2]

where in Chemical formula 2, 0.01≤x≤0.5.

In an embodiment of the disclosure, the sulfide solid-state electrolyte is represented by Chemical formula 3,

Li_{6+y}P_{1-y}Ti_{y}S_{5-2y}BrO_{2y} [Chemical formula 3]

where in Chemical formula 3, 0.01≤y≤0.5.

In an embodiment of the disclosure, the solid-state electrolyte layer has a dual-layer structure. The dual-layer structure includes a first layer and a second layer stacked on each other. The first layer is disposed between the negative electrode and the second layer, and the second layer is disposed between the positive electrode and the first layer.

In an embodiment of the disclosure, the first layer of the solid-state electrolyte layer includes the sulfide solid-state electrolyte, and the second layer of the solid-state electrolyte layer includes a halide solid-state electrolyte.

In an embodiment of the disclosure, the halide solid-state electrolyte is selected from a group consisting of Li₃InCl₆, Li₃AlF₆, Li₃GaF₆, Li₃YCl₆, and Li₃YBr₆.

In an embodiment of the disclosure, the positive electrode includes a positive active material, a solid-state electrolyte, and a conductive additive.

In an embodiment of the disclosure, the positive active material includes LiNi_{0.9}Co_{0.05}Mn_{0.5}O₂, LiNi_{0.8}Co_{0.1}Mn_{0.1}O₂, LiNi_{0.6}Co_{0.2}Mn_{0.2}O₂, LiNi_{0.6}Co_{0.1}Mn_{0.3}O₂, LiNi_{0.5}Co_{0.2}Mn_{0.3}O₂, LiFePO₄, Li(FeₓMn₁₋ₓ)PO₄, or a combination thereof.

In an embodiment of the disclosure, the solid-state electrolyte in the positive electrode includes a halide solid-state electrolyte.

In an embodiment of the disclosure, the negative electrode includes lithium, indium, lithium-indium alloy, or a combination thereof.

Based on the above, the solid-state battery in the disclosure includes the sulfide solid-state electrolyte represented by Chemical formula 1 (Li_{6+x+y}P_{1-x-y}SiₓTi_{y}S_{5-2x-2y}BrO_{2x+2y}, where 0≤x≤0.5, 0≤y≤0.5, and x+y>0). Therefore, it may have good ionic conductivity, while improving the chemical stability and voltage stability of the sulfide solid-state electrolyte, thereby improving the cycle life of the solid-state battery.

### BRIEF DESCRIPTION OF THE DRAWINGS

FIG. 1 is a schematic view of a solid-state battery according to an embodiment of the disclosure.

FIG. 2 is a result of performing a hydrogen sulfide production amount test on solid-state electrolytes in Synthesis Examples 2 and 5 as well as Comparative Synthesis Example.

FIG. 3 is a result of performing a linear sweep voltammetry measurement on solid-state electrolytes in Synthesis Example 2 and Comparative Synthesis Example.

FIG. 4 is a result of performing a linear sweep voltammetry measurement on solid-state electrolytes in Synthesis Example 5 and Comparative Synthesis Example.

FIG. 5 is a result of performing a limiting current density test on a symmetrical battery obtained in Comparative Synthesis Example.

FIG. 6 is a result of performing a limiting current density test on a symmetrical battery obtained in Synthesis Example 2.

FIG. 7 is a result of performing a limiting current density test on a symmetrical battery obtained in Synthesis Example 5.

FIG. 8 is a charge-discharge curve in Comparative Example.

FIG. 9 is a charge-discharge curve in Example 1.

FIG. 10 is a charge-discharge curve in Example 2.

FIG. 11 shows a relationship between a number of charge-discharge cycles, discharge capacitance, and coulombic efficiency in Comparative Example, Example 1, and Example 2.

### DETAILED DESCRIPTION OF DISCLOSED EMBODIMENTS

In the drawings, the thickness of layers, films, panels, regions, etc., is exaggerated for clarity. Throughout the specification, the same reference numerals represent the same elements. It should be understood that when an element such as a layer, a film, a region, or a substrate is referred to as being “on” another element or “connected to” another element, the element may be directly on the another element or connected to the another element, or there may be an intermediate element. In contrast, when an element is referred to as being “directly on” another element or “directly connected to” another element, there is no intermediate element. As used herein, “connection” may refer to physical and/or electrical connection. Furthermore, “electrical connection” or “coupling” may be that there is another element between two elements.

It should be understood that although terms such as “first” and “second” may be used herein to describe various elements, components, regions, layers, and/or portions, the elements, components, regions, and/or portions are not limited by the terms. The terms are only used to distinguish one element, component, region, layer, or portion from another element, component, region, layer, or portion. Therefore, a first “element”, “component”, “region”, “layer”, or “portion” discussed below may be referred to as a second element, component, region, layer, or portion without departing from the teachings herein.

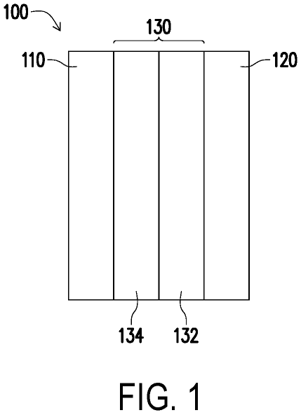

FIG. 1 is a schematic view of a solid-state battery according to an embodiment of the disclosure.

Referring to FIG. 1, a solid-state battery 100 includes a positive electrode 110, a negative electrode 120, and a solid-state electrolyte layer 130. The solid-state electrolyte layer 130 is disposed between the positive electrode 110 and the negative electrode 120. The solid-state electrolyte layer 130 includes a sulfide solid-state electrolyte. The sulfide solid-state electrolyte is represented by Chemical formula 1.

Li_{6+x+y}P_{1-x-y}SiₓTi_{y}S_{5-2x-2y}BrO_{2x+2y} [Chemical formula 1]

In Chemical formula 1, 0≤x≤0.5, 0≤y≤0.5, and x+y>0.

In some embodiments, in Chemical formula 1, 0<x+y≤0.5. In this way, stability of the sulfide solid-state electrolyte may be improved, reducing a possibility of the sulfide solid-state electrolyte decomposing in the air or under a high voltage, thereby increasing cycle life of the solid-state battery 100.

In some embodiments, the sulfide solid-state electrolyte may be represented by Chemical formula 2.

Li₆₊ₓP₁₋ₓSiₓS₅₋₂ₓBrO₂ₓ [Chemical formula 2]

In Chemical formula 2, 0.01≤x≤0.5.

In some embodiments, the sulfide solid-state electrolyte may be represented by Chemical formula 3.

Li_{6+y}P_{1-y}Ti_{y}S_{5-2y}BrO_{2y} [Chemical formula 2]

In Chemical formula 2, 0.01≤y≤0.5.

In some embodiments, the sulfide solid-state electrolyte is formed by doping Li₆PS₅Br with silicon dioxide (SiO₂) and/or titanium dioxide (TiO₂). Since Li₆PS₅Br is doped and modified with silicon dioxide (SiO₂) and/or titanium dioxide (TiO₂), it may increase structural stability of the sulfide solid-state electrolyte and reduce a possibility of decomposition of the sulfide solid-state electrolyte due to reaction with water in the atmosphere or decomposition under the high voltage, so that the stability thereof is improved, thereby increasing the cycle life of the solid-state battery 100.

In some embodiments, the solid-state electrolyte layer 130 may be a dual-layer structure. For example, the solid-state electrolyte layer 130 includes a first layer 132 and a second layer 134. The first layer 132 may include the sulfide solid-state electrolyte as represented by Chemical formulas 1, 2, or 3 as previously described. The second layer 134 may include a halide solid-state electrolyte. The halide solid-state electrolyte may be selected from a group consisting of Li₃InCl₆, Li₃AlF₆, Li₃GaF₆, Li₃YCl₆, and Li₃YBr₆, but the disclosure is not limited thereto. In other embodiments, the solid-state electrolyte layer 130 may be a single layer structure including the sulfide solid-state electrolyte as represented by Chemical formulas 1, 2, or 3 as previously described.

In some embodiments, the first layer 132 may be disposed between the negative electrode 120 and the second layer 134, and the second layer 134 may be disposed between the positive electrode 110 and the first layer 132. In this way, a material of the positive electrode 110 may be prevented from reacting with the sulfide solid-state electrolyte of the first layer 132.

In some embodiments, the positive electrode 110 includes a positive active material, a solid-state electrolyte, and a conductive additive. The positive active material may include, for example, LiNi_{0.8}Co_{0.1}Mn_{0.1}O₂, LiNi_{0.6}Co_{0.2}Mn_{0.2}O₂, LiNi_{0.6}Co_{0.1}Mn_{0.3}O₂, LiNi_{0.5}Co_{0.2}Mn_{0.3}O₂, or a combination thereof. In some embodiments, the positive active material may be a single crystal material or a polycrystal material, but the disclosure is not limited thereto. The conductive additive may include, for example, carbon black, vapor grown carbon fiber (VGCF), carbon nanotubes, graphene, a combination thereof, or other suitable conductive additives. The solid-state electrolyte in the positive electrode 110 may include, for example, the halide solid-state electrolyte. Specific examples of the halide solid-state electrolyte may be referred to the foregoing description. Therefore, the same details will not be repeated in the following.

In some embodiments, the positive electrode 110 further includes an adhesive to bind the positive active material, the solid-state electrolyte, and the conductive additive together. The adhesive may include, for example, polytetrafluoroethylene (PTFE), polyvinylidene difluoride (PVDF), or other suitable adhesives, but the disclosure is not limited thereto.

In some embodiments, the negative electrode 120 may include lithium, indium, lithium-indium alloy, a combination thereof, or other suitable negative electrode materials. In some embodiments, the negative electrode 120 may further include the solid-state electrolyte, and the solid-state electrolyte may, for example, be selected from a group consisting of the halide solid-state electrolyte and the sulfide solid-state electrolyte (specific examples of the halide solid-state electrolyte and the sulfide solid-state electrolyte may be referred to the foregoing description, and thus the same details will not be repeated in the following). However, the disclosure is not limited thereto.

In this embodiment, since the solid-state battery includes the sulfide solid-state electrolyte represented by Chemical formula 1, it may improve chemical stability and voltage stability of the sulfide solid-state electrolyte while maintaining good ionic conductivity, thereby improving the cycle life of the solid-state battery.

The following experiments are listed to verify the efficacy of the disclosure, but the disclosure is not limited to the following content. The materials used, their amounts and ratios, processing details, processing procedures, etc. may be appropriately changed without departing from the scope of the disclosure. Therefore, the disclosure should not be interpreted restrictively by the examples described below.

### [Synthesis of Sulfide Solid-State Electrolyte]

### Synthesis Example 1: Li_{6.1}P_{0.9}Ti_{0.1}S_{4.8}BrO_{0.2}

First, Li₂S of 1.1266 g, LiBr of 0.8350 g, TiO₂ of 0.0768 g, and P₂S₅ of 0.9617 g were taken to be put into a mortar and ground roughly for 10 minutes to mix powder evenly. Then the mixed powder and zirconium oxide beads (diameter=10 mm) were put into a zirconium oxide ball mill jar at a weight ratio (powder:zirconium oxide beads) of 1:10. Next, the ball mill jar was put into a ball mill, and ball milling was performed at 500 rpm for 20 hours. The ball mill jar will be taken out every 5 hours to remove the powder on a tank wall to prevent the powder from depositing on the tank wall and causing uneven synthesis. After that, the ball-milled powder was put into a quartz tube with a carbon layer on an inner wall. A maintainer and a vacuum system were used to reduce a pressure in the quartz tube to 2*10-2 Torr and then seal the tube. Finally, the quartz tube containing a sample was sintered at a sintering temperature of 500° C. and kept at the temperature for 5 hours before naturally lowering to a room temperature to obtain Li_{6.1}P_{0.9}Ti_{0.1}S_{4.8}BrO_{0.2}.

### Synthesis Example 2: Li_{6.2}P_{0.8}Ti_{0.2}S_{4.6}BrO_{0.4}

First, Li₂S of 1.1517 g, LiBr of 0.8372 g, TiO₂ of 0.1540 g, and P₂S₅ of 0.8571 g were taken to be put into the mortar and ground roughly for 10 minutes to mix powder evenly. Then the mixed powder and the zirconium oxide beads (diameter=10 mm) were put into the zirconium oxide ball mill jar at the weight ratio (powder:zirconium oxide beads) of 1:10. Next, the ball mill jar was put into the ball mill, and the ball milling was performed at 500 rpm for 20 hours. The ball mill jar will be taken out every 5 hours to remove the powder on the tank wall to prevent the powder from depositing on the tank wall and causing uneven synthesis. After that, the ball-milled powder was put into the quartz tube with the carbon layer on an inner wall. The maintainer and the vacuum system were used to reduce the pressure in the quartz tube to 2*10-2 Torr and then seal the tube. Finally, the quartz tube containing the sample was sintered at the sintering temperature of 500° C. and kept at the temperature for 5 hours before naturally lowering to the room temperature to obtain Li_{6.2}P_{0.8} Ti_{0.2}S_{4.6}BrO_{0.4}.

### Synthesis Example 3: Li_{6.3}P_{0.7}Ti_{0.3}S_{4.4}BrO_{0.6}

First, Li₂S of 0.9388 g, LiBr of 0.8403 g, TiO₂ of 0.2225 g, and P₂S₅ of 1.0314 g were taken to be put into the mortar and ground roughly for 10 minutes to mix powder evenly. Then the mixed powder and the zirconium oxide beads (diameter=10 mm) were put into the zirconium oxide ball mill jar at the weight ratio (powder:zirconium oxide beads) of 1:10. Next, the ball mill jar was put into the ball mill, and the ball milling was performed at 500 rpm for 20 hours. The ball mill jar will be taken out every 5 hours to remove the powder on the tank wall to prevent the powder from depositing on the tank wall and causing uneven synthesis. After that, the ball-milled powder was put into the quartz tube with the carbon layer on an inner wall. The maintainer and the vacuum system were used to reduce the pressure in the quartz tube to 2*10-2 Torr and then seal the tube. Finally, the quartz tube containing the sample was sintered at the sintering temperature of 500° C. and kept at the temperature for 5 hours before naturally lowering to the room temperature to obtain Li_{6.3}P_{0.7}Ti_{0.3}S_{4.4}BrO_{0.6}.

### Synthesis Example 4: Li_{6.1}P_{0.9}Si_{0.1}S_{4.8}BrO_{0.2}

First, Li₂S of 1.1337 g, LiBr of 0.8403 g, SiO₂ of 0.0581 g, and P₂S₅ of 0.9678 g were taken to be put into the mortar and ground roughly for 10 minutes to mix powder evenly. Then the mixed powder and the zirconium oxide beads (diameter=10 mm) were put into the zirconium oxide ball mill jar at the weight ratio (powder:zirconium oxide beads) of 1:10. Next, the ball mill jar was put into the ball mill, and the ball milling was performed at 500 rpm for 20 hours. The ball mill jar will be taken out every 5 hours to remove the powder on the tank wall to prevent the powder from depositing on the tank wall and causing uneven synthesis. After that, the ball-milled powder was put into the quartz tube with the carbon layer on an inner wall. The maintainer and the vacuum system were used to reduce the pressure in the quartz tube to 2*10⁻² Torr and then seal the tube. Finally, the quartz tube containing the sample was sintered at the sintering temperature of 500° C. and kept at the temperature for 5 hours before naturally lowering to the room temperature to obtain Li_{6.1}P_{0.9}Si_{0.1}S_{4.8}BrO_{0.2}.

### Synthesis Example 5: Li_{6.3}P_{0.7}Si_{0.3}S_{4.4}BrO_{0.6}

First, Li₂S of 1.200 g, LiBr of 0.8558 g, SiO₂ of 0.1776 g, and P₂S₅ of 0.7666 g were taken to be put into the mortar and ground roughly for 10 minutes to mix powder evenly. Then the mixed powder and the zirconium oxide beads (diameter=10 mm) were put into the zirconium oxide ball mill jar at the weight ratio (powder:zirconium oxide beads) of 1:10. Next, the ball mill jar was put into the ball mill, and the ball milling was performed at 500 rpm for 20 hours. The ball mill jar will be taken out every 5 hours to remove the powder on the tank wall to prevent the powder from depositing on the tank wall and causing uneven synthesis. After that, the ball-milled powder was put into the quartz tube with the carbon layer on an inner wall. The maintainer and the vacuum system were used to reduce the pressure in the quartz tube to 2*10-2 Torr and then seal the tube. Finally, the quartz tube containing the sample was sintered at the sintering temperature of 500° C. and kept at the temperature for 5 hours before naturally lowering to the room temperature to obtain Li_{6.3}P_{0.7}Si_{0.3}S_{4.4}BrO_{0.6}.

### Synthesis Example 6: Li_{6.5}P_{0.5}Si_{0.5}S_{4.0}BrO_{1.0}

First, Li₂S of 1.2686 g, LiBr of 0.8719 g, SiO₂ of 0.3016 g, and P₂S₅ of 0.5579 g were taken to be put into the mortar and ground roughly for 10 minutes to mix powder evenly. Then the mixed powder and the zirconium oxide beads (diameter=10 mm) were put into the zirconium oxide ball mill jar at the weight ratio (powder:zirconium oxide beads) of 1:10. Next, the ball mill jar was put into the ball mill, and the ball milling was performed at 500 rpm for 20 hours. The ball mill jar will be taken out every 5 hours to remove the powder on the tank wall to prevent the powder from depositing on the tank wall and causing uneven synthesis. After that, the ball-milled powder was put into the quartz tube with the carbon layer on an inner wall. The maintainer and the vacuum system were used to reduce the pressure in the quartz tube to 2*10-2 Torr and then seal the tube. Finally, the quartz tube containing the sample was sintered at the sintering temperature of 500° C. and kept at the temperature for 5 hours before naturally lowering to the room temperature to obtain Li_{6.5}P_{0.5}Si_{0.5}S_{4.0}BrO_{1.0}.

### Comparative Synthesis Example: Li₆PS₅Br

First, Li₂S of 1.1015 g, LiBr of 0.8328 g, TiO₂ of 0.2225 g, and P₂S₅ of 1.0657 g were taken to be put into the mortar and ground roughly for 10 minutes to mix powder evenly. Then the mixed powder and the zirconium oxide beads (diameter=10 mm) were put into the zirconium oxide ball mill jar at the weight ratio (powder:zirconium oxide beads) of 1:10. Next, the ball mill jar was put into the ball mill, and the ball milling was performed at 500 rpm for 20 hours. The ball mill jar will be taken out every 5 hours to remove the powder on the tank wall to prevent the powder from depositing on the tank wall and causing uneven synthesis. After that, the ball-milled powder was put into the quartz tube with the carbon layer on an inner wall. The maintainer and the vacuum system were used to reduce the pressure in the quartz tube to 2*10-2 Torr and then seal the tube. Finally, the quartz tube containing the sample was sintered at the sintering temperature of 500° C. and kept at the temperature for 5 hours before naturally lowering to the room temperature to obtain Li₆PS₅Br.

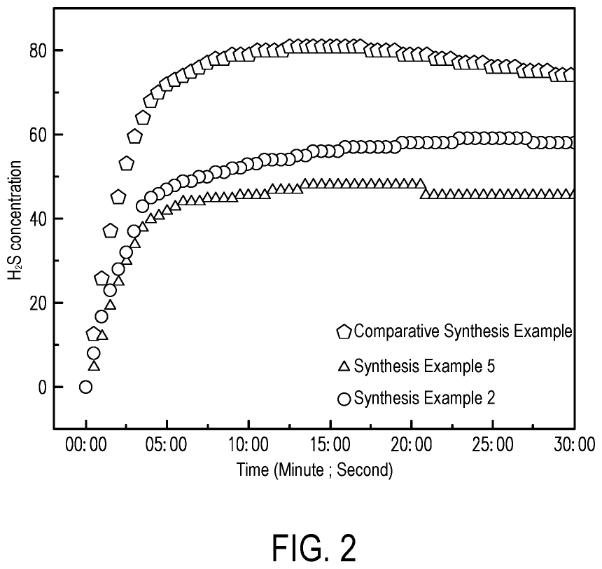

Ion conductivity of Synthesis Examples 1 to 6 and Comparative Synthesis Example was measured using a solid-state electrolyte pressing mold KP cell at the room temperature, and results were thereof are recorded in Table 1. In addition, Synthesis Examples 2 and 5 as well as Comparative Synthesis Example were exposed to the air for 30 minutes, and changes in concentration of hydrogen sulfide (H₂S) during this period was measured. Results thereof were shown in Table 1 and FIG. 2. FIG. 2 is a result of performing a hydrogen sulfide production amount test on solid-state electrolytes in Synthesis Examples 2 and 5 as well as Comparative Synthesis Example.

TABLE 1

| | | | Production |
|---|---|---|---|
| | Chemical | Ion Conductivity | Concentration |
| Sample | Composition | (S/cm) | of H₂S (ppm) |
| Comparative | Li₆PS₅Br | 9.37*10⁻⁴ | 81 |
| Synthesis Example | | | |
| Synthesis Example 1 | Li_{6.1}P_{0.9}Ti_{0.1}S_{4.8}BrO_{0.2} | 1.22*10⁻³ | (not measured) |
| Synthesis Example 2 | Li_{6.2}P_{0.8}Ti_{0.2}S_{4.6}BrO_{0.4} | 1.55*10⁻³ | 61 |
| Synthesis Example 3 | Li_{6.3}P_{0.7}Ti_{0.3}S_{4.4}BrO_{0.6} | 6.99*10⁻⁴ | (not measured) |
| Synthesis Example 4 | Li_{6.1}P_{0.9}Si_{0.1}S_{4.8}BrO_{0.2} | 1.55*10⁻³ | (not measured) |
| Synthesis Example 5 | Li_{6.3}P_{0.7}Si_{0.3}S_{4.4}BrO_{0.6} | 3.37*10⁻³ | 46 |
| Synthesis Example 6 | Li_{6.5}P_{0.5}Si_{0.5}S_{4.0}BrO_{1.0} | 1.19*10⁻³ | (not measured) |

According to Table 1 and FIG. 2, compared to the undoped sulfide solid-state electrolyte (i.e., Comparative Synthesis Example), the sulfide solid-state electrolyte doped with TiO₂ or SiO₂ (i.e., Synthesis Examples 1 to 6) had better performance at the room temperature and may reduce the production of hydrogen sulfide, thereby improving the chemical stability of the sulfide solid-state electrolyte.

In addition, the solid-state electrolytes in Synthesis Examples 2 and 5 as well as Comparative Synthesis Example were respectively sandwiched between two lithium electrodes to form a symmetrical battery, and then a linear sweep voltammetry measurement, a limiting current density test, and a long cycle test were performed.

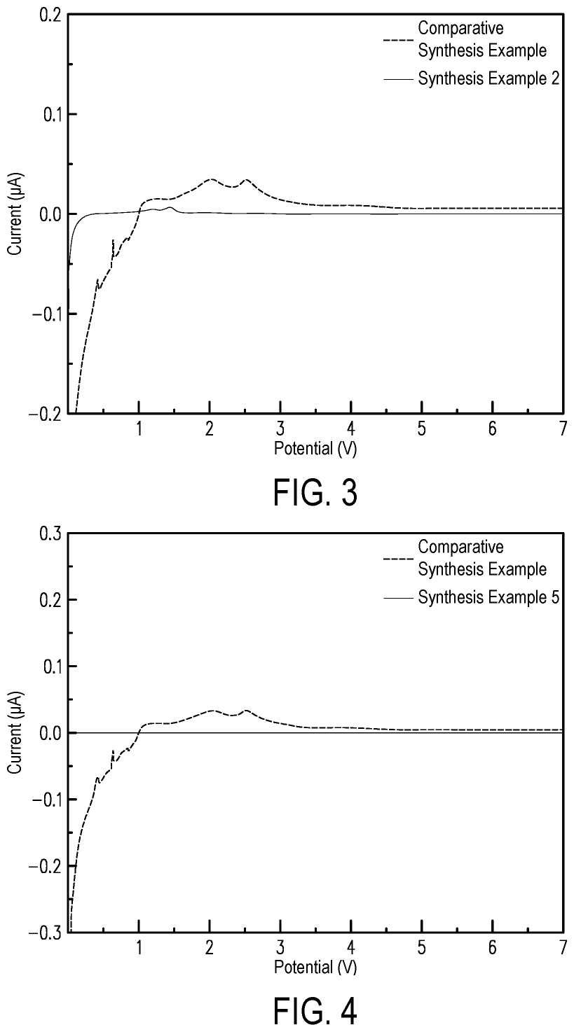

The linear sweep voltammetry measurement was to measure current changes of the symmetrical battery obtained in Synthesis Examples 2 and 5 as well as Comparative Synthesis Example in a voltage range from 0 V to 7 V at a sweep speed of 0.1 mV/s. FIG. 3 is a result of performing a linear sweep voltammetry measurement on solid-state electrolytes in Synthesis Example 2 and Comparative Synthesis Example. FIG. 4 is a result of performing a linear sweep voltammetry measurement on solid-state electrolytes in Synthesis Example 5 and Comparative Synthesis Example.

According to FIGS. 3 and 4, compared to Comparative Synthesis Example where a current fluctuates up and down when a voltage is increased, in Synthesis example 2 and Synthesis example 5, the current performance is stable when the voltage is increased. It can be seen that the TiO₂ or SiO₂ doped with the sulfide solid-state electrolyte had good stability under high pressure.

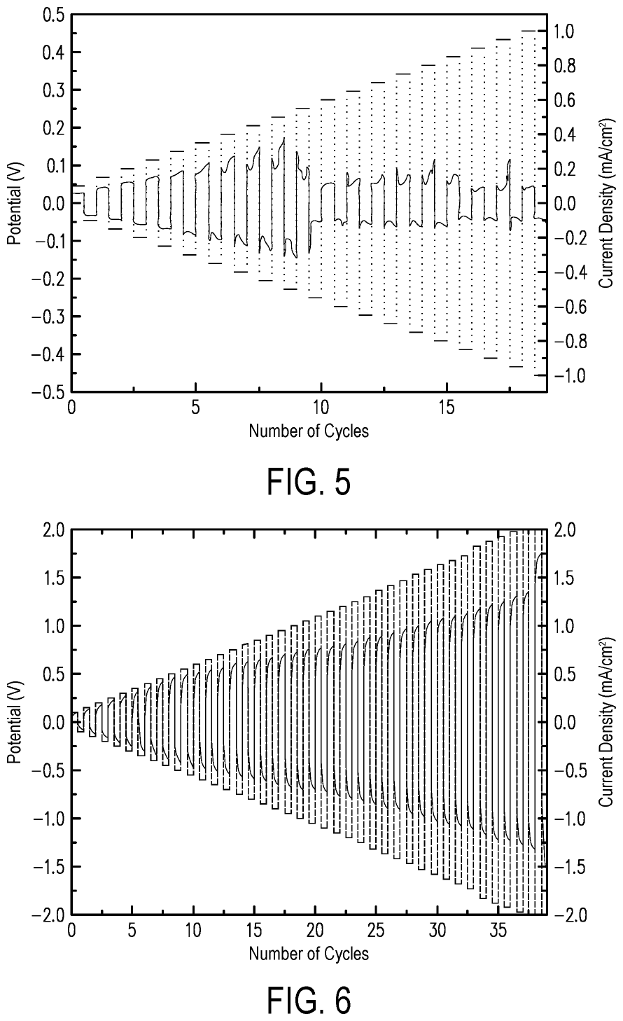

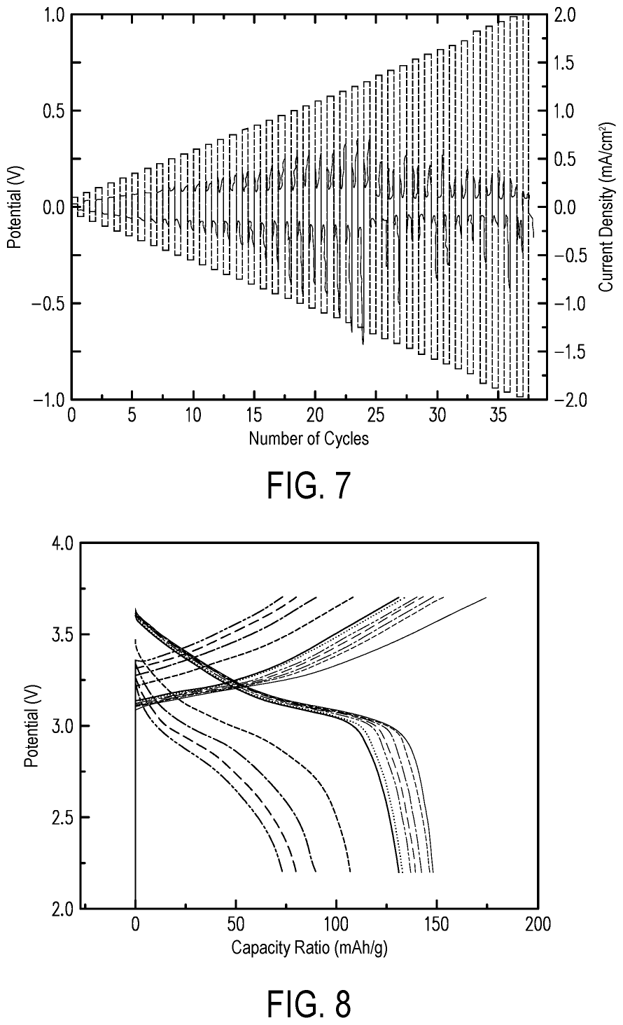

The limiting current density test was to measure potential changes in the symmetrical battery obtained in Synthesis Examples 2 and 5 as well as Comparative Synthesis Example, starting from a current density of 0.05 mA/cm² and increasing the current density by 0.05 mA/cm² per cycle, and the charge and discharge time per cycle was 2 minutes. When the potential dropped sharply, it indicated that the battery had failed. FIG. 5 is a result of performing a limiting current density test on a symmetrical battery obtained in Comparative Synthesis Example. FIG. 6 is a result of performing a limiting current density test on a symmetrical battery obtained in Synthesis Example 2. FIG. 7 is a result of performing a limiting current density test on a symmetrical battery obtained in Synthesis Example 5. In FIGS. 5 to 7, the ordinate on the left is a value corresponding to a solid line, and the ordinate on the right is a value corresponding to a dashed line.

According to FIGS. 5 to 7, a limiting current density of the symmetrical battery obtained in Comparative Synthesis Example was approximately 0.5 mA/cm², a limiting current density of the symmetrical battery obtained in Synthesis Example 2 was approximately 2.0 mA/cm², and a limiting current density of the symmetrical battery obtained in Synthesis Example 5 was approximately 1.25 mA/cm². As a result, the sulfide solid-state electrolyte doped with TiO₂ or SiO₂ helped to increase the limiting current density of the solid-state battery.

The long cycle test was to perform a lithium-lithium recharge test on the symmetrical battery obtained in Synthesis Examples 2 and 5 as well as Comparative Synthesis Example at a current density of 0.1 mA/cm², and each cycle time was 1 hour, so as to measure potential changes thereof. When the potential dropped sharply, it indicated that the battery had failed.

Results of the long cycle test showed that the symmetrical battery obtained in Comparative Synthesis Example may continuously cycle for 18 times in the long cycle test, the symmetrical battery obtained in Synthesis Example 2 may continuously cycle for 30 times in the long cycle test, and the symmetrical battery obtained in Synthesis Example 5 may continuously cycle for 30 times in the long cycle test. As a result, the sulfide solid-state electrolyte doped with TiO₂ or SiO₂ helped to increase the cycle life of the solid-state battery.

### [Preparation of Solid-State Battery]

### Example 1

Preparation of the positive electrode: a single crystal of -LiNi_{0.6}Co_{0.1}Mn_{0.3}O₂ (SC-NCM613) (the positive active material), Li₃InCl₆ (the solid-state electrolyte), and VGCF (the conductive additive) were put into the mortar in a weight ratio of 70:30:3 to be mixed evenly, and then PTFE (adhesive) of 3% by weight was added to form a thin film. The thin film was rolled to a thickness of 50 μm and cut into a circle with a diameter of 10 mm.

Preparation of the solid-state electrolyte layer: Li₃InCl₆ powder of 0.5 g was taken and put into the mold, and cold-pressed at a pressure of 360 MPa to form a first layer tablet, and then the powder of 0.7 g in Synthesis Example 2 was taken and put into the mold, and cold-pressed at a pressure of 360 MPa to form a second layer tablet, thereby preparing a double-layer electrolyte layer tablet.

Preparation of the negative electrode: indium metal and lithium metal were cut into a circle with a diameter of 10 mm with a hole punch, and then the indium metal was put on the top, and the lithium metal was put on the bottom to be stacked together and cold-pressed at a pressure of 20 MPa to from a lithium-indium alloy negative electrode. A weight ratio of the lithium metal to the indium metal is 2:55.

Preparation of the solid-state battery: a lower cover, aluminum foil, the positive electrode, the solid-state electrolyte layer, the negative electrode, a stainless pad, a reed, and an upper cover were put into a CR-2032 button battery in sequence. The first layer tablet of the solid-state electrolyte layer was disposed facing the positive electrode, and the second layer tablet was disposed facing the positive electrode and the negative electrode. Then, a hydraulic machine is used to press the battery at a pressure of 200 MPa. The above processes were all performed in a glove box filled with argon to ensure that the sample will not be affected by water and oxygen.

### Example 2

The experiment is similar to a preparation method in Example 1 above. However, the second layer tablet in Example 2 is obtained by cold pressing in Synthesis Example 5.

### Comparative Example

The experiment is similar to the preparation method in Example 1 above. However, the second layer tablet in Comparative Example is obtained by cold pressing in Comparative Synthesis Example.

A charge-discharge cycle test was performed on the solid-state battery in Examples 1 to 2 and Comparative Example. Test conditions were 3 cycles at 0.05 C and 50 cycles at 0.1 C. A voltage range is 2.2 to 3.7 V in an environment of 55° C.

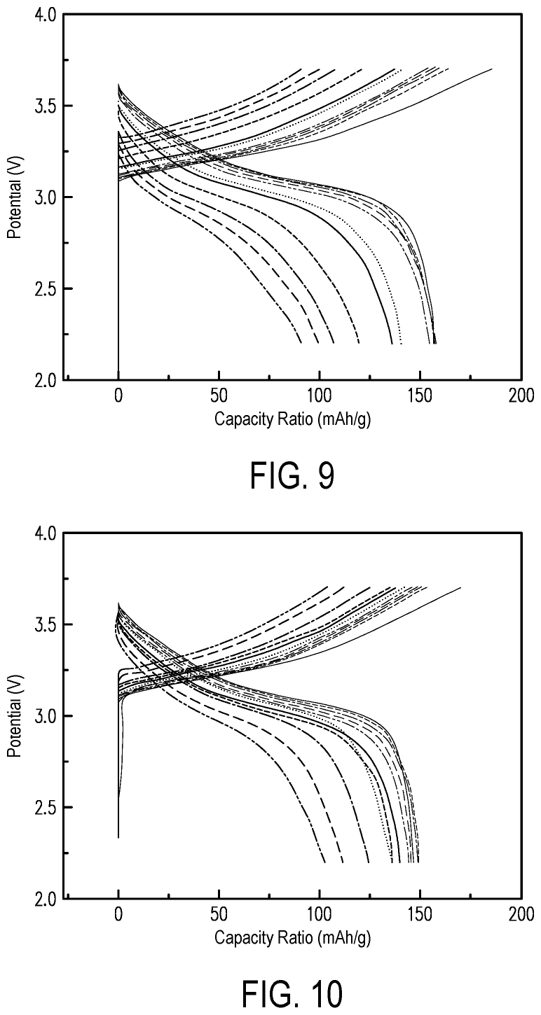

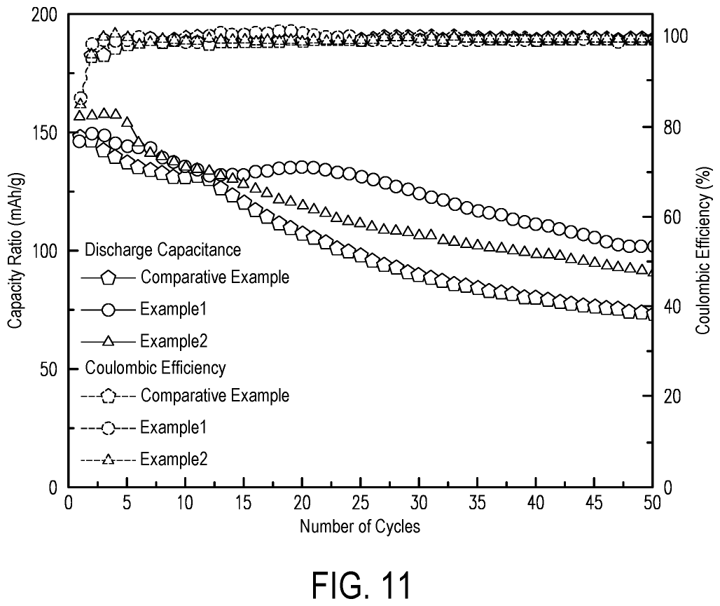

FIG. 8 is a charge-discharge curve in Comparative Example. FIG. 9 is a charge-discharge curve in Example 1. FIG. 10 is a charge-discharge curve in Example 2. FIG. 11 shows a relationship between a number of charge-discharge cycles, discharge capacitance, and coulombic efficiency in Comparative Example, Example 1, and Example 2. In FIG. 11, the ordinate on the left is a value corresponding to a solid line pattern, and the ordinate on the right is a value corresponding to a dashed line pattern.

According to FIGS. 5 to 8, the solid-state battery in Comparative Example had a reversible capacity of 147.8 mAh/g in a first cycle, and maintained a capacity retention rate of 49.3% after 50 charge-discharge cycles. The solid-state battery in Example 1 had a reversible capacity of 157.0 mAh/g in the first cycle, and maintained a capacity retention rate of 57.9% after the 50 charge-discharge cycles. The solid-state battery in Example 2 had a reversible capacity of 146.5 mAh/g in the first cycle, and maintained a capacity retention rate of 69.1% after the 50 charge-discharge cycles. As a result, compared to Comparative Example, in Example 1 and Example 2, the capacity retention rate was significantly improved, which helped to improve the cycle life of the solid-state battery.

Based on the above, the solid-state battery in the disclosure includes the sulfide solid-state electrolyte represented by Chemical formula 1 (Li_{6+x+y}P_{1-x-y}SiₓTi_{y}S_{5-2x-2y}BrO_{2x+2y}, where 0≤x≤0.5, 0≤y≤0.5, and x+y>0). Therefore, it may have good ionic conductivity, while improving the chemical stability and voltage stability of the sulfide solid-state electrolyte, thereby improving the cycle life of the solid-state battery.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A solid-state battery, comprising:
a positive electrode;
a negative electrode; and
a solid-state electrolyte layer disposed between the positive electrode and the negative electrode, wherein the solid-state electrolyte layer comprises a sulfide solid-state electrolyte, and the sulfide solid-state electrolyte is represented by Chemical formula 1,
Li_{6+x+y}P_{1-x-y}SiₓTi_{y}S_{5-2x-2y}BrO_{2x+2y} [Chemical formula 1]
wherein in Chemical formula 1, 0≤x≤0.5, 0≤y≤0.5, and x+y>0.

2. The solid-state battery according to claim 1, wherein the sulfide solid-state electrolyte is represented by Chemical formula 2,
Li₆₊ₓP₁₋ₓSiₓS₅₋₂ₓBrO₂ₓ [Chemical formula 2]
wherein in Chemical formula 2, 0.01≤x≤0.5.

3. The solid-state battery according to claim 1, wherein the sulfide solid-state electrolyte is represented by Chemical formula 3,
Li_{6+y}P_{1-y}Ti_{y}S_{5-2y}BrO_{2y} [Chemical formula 3]
wherein in Chemical formula 3, 0.01≤y≤0.5.

4. The solid-state battery according to claim 1, wherein the solid-state electrolyte layer has a dual-layer structure, the dual-layer structure comprises a first layer and a second layer stacked on each other, the first layer is disposed between the negative electrode and the second layer, and the second layer is disposed between the positive electrode and the first layer.

5. The solid-state battery according to claim 4, wherein the first layer of the solid-state electrolyte layer comprises the sulfide solid-state electrolyte, and the second layer of the solid-state electrolyte layer comprises a halide solid-state electrolyte.

6. The solid-state battery according to claim 5, wherein the halide solid-state electrolyte is selected from a group consisting of Li₃InCl₆, Li₃AlF₆, Li₃GaF₆, Li₃YCl₆, and Li₃YBr₆.

7. The solid-state battery according to claim 1, wherein the positive electrode comprises a positive active material, a solid-state electrolyte, and a conductive additive.

8. The solid-state battery according to claim 7, wherein the positive active material comprises LiNi_{0.8}Co_{0.1}Mn_{0.1}O₂, LiNi_{0.6}Co_{0.2}Mn_{0.2}O₂, LiNi_{0.6}Co_{0.1}Mn_{0.3}O₂, LiNi_{0.5}Co_{0.2}Mn_{0.3}O₂, or a combination thereof.

9. The solid-state battery according to claim 7, wherein the solid-state electrolyte in the positive electrode comprises a halide solid-state electrolyte.

10. The solid-state battery according to claim 1, wherein the negative electrode comprises lithium, indium, lithium-indium alloy, or a combination thereof.
